(19) United States
(12) Patent Application Publication
(10) Pub. No.: US 2026/0302316 A1
(43) Pub. Date: Oct. 1, 2026

(54) BATTERY MODULE

(71) Applicant: HONDA MOTOR CO., LTD., Tokyo (JP)

(72) Inventors: Mahiro SAWADA, Saitama (JP); Tatsuya SEKI, Saitama (JP); Anri ISHIDE, Saitama (JP); Hidemasa USUI, Saitama (JP); Kazutaka SUZUKI, Saitama (JP)

(21) Appl. No.: 19/577,816

(22) Filed: Mar. 25, 2026

(30) Foreign Application Priority Data
Mar. 31, 2025 (JP) 2025060065

(51) Int. Cl. H01M 10/04; H01M 4/02; H01M 4/40; H01M 50/204; H01M 50/291; H01M 50/293

(52) U.S. Cl. CPC H01M 10/0468; H01M 4/405; H01M 50/204; H01M 50/291; H01M 50/293; H01M 2004/027

(57) ABSTRACT

A battery module is provided, the battery module including a battery-cell laminate in which a plurality of battery cells are stacked, and an elastic member disposed between the plurality of battery cells, in which the elastic member includes a pouch including a first sealing portion and a second sealing portion at both ends, respectively, in a direction perpendicular to a stacking direction of the battery cells, a gas being sealed in the pouch, and in which a non-facing region, which is a region between the first sealing portion and the second sealing portion and does not face the battery cells, is reinforced by a reinforcing member.

This application is based on and claims the benefit of priority from Japanese Patent Application No. 2025-060065, filed on 31 Mar. 2025, the content of which is incorporated herein by reference.

### BACKGROUND OF THE INVENTION

### Field of the Invention

The present invention relates to a battery module.

### Related Art

In recent years, research and development has been conducted on battery modules that contribute to energy efficiency, in order to ensure that a greater number of people can have access to affordable, reliable, sustainable, and advanced energy.

Japanese Unexamined Patent Application, Publication No. 2003-303579 discloses a module including a flat secondary battery. In this case, the module includes a module casing that fixes the flat secondary battery while applying pressure to the flat secondary battery, and a fluid-containing bag that contains a fluid in a sealed state, the fluid-containing bag being disposed between the module casing and the flat secondary battery.
Patent Document 1: Japanese Unexamined Patent Application, Publication No. 2003-303579

### SUMMARY OF THE INVENTION

However, when the fluid-containing bag disclosed in Japanese Unexamined Patent Application, Publication No. 2003-303579 is disposed between a plurality of battery cells, the battery cells expand and contract during charging and discharging of the battery cells, and therefore the fluid-containing bag tends to be damaged.

An object of the present invention is to provide a battery module in which damage to a pouch can be reduced.

(1) A battery module including a battery-cell laminate in which a plurality of battery cells are stacked, and an elastic member disposed between the plurality of battery cells, in which the elastic member includes a pouch including a first sealing portion and a second sealing portion at both ends, respectively, in a direction perpendicular to a stacking direction of the battery cells, a gas being sealed in the pouch, and in which a non-facing region, which is a region between the first sealing portion and the second sealing portion and does not face the battery cells, is reinforced by a reinforcing member.

(2) The battery module as described in the item (1), in which a ratio of a width of the reinforcing member to a length of the non-facing region, when the elastic member is viewed in cross-section from a direction perpendicular to a stacking direction of the battery cells, is 1.0 or more.

(3) The battery module as described in the item (1) or (2), in which a ratio of a width of the reinforcing member to a length, in the direction perpendicular to the stacking direction of the battery cells, of the pouch is between 0.001 and 0.05 inclusive.

(4) The battery module according to any one of items (1) to (3), in which a ratio of a thickness of the reinforcing member to a thickness of the pouch is between 0.03 and 0.20 inclusive.

(5) The battery module according to any one of items (1) to (4), in which, when the elastic member is viewed in cross-section from a direction perpendicular to a stacking direction of the battery cells and a length of the non-facing region is x₀ [mm] and an internal pressure of the pouch is y [N/mm²], the reinforcing member has a tensile strength of x₀×y [N/mm] or more.

(6) The battery module as described in the item (5), in which x₀×y is between 1 N/mm and 20 N/mm inclusive.

(7) The battery module as described in the item (5) or (6), in which x₀ is between 1.0 mm and 4.0 mm inclusive.

(8) The battery module according to any one of items (1) to (7), in which an internal pressure of the pouch is between 0.1 MPa and 3.0 MPa inclusive.

(9) The battery module according to any one of items (1) to (8), in which a ratio of the length, in the direction perpendicular to the stacking direction of the battery cells, of the non-facing region to a length, in the direction perpendicular to the stacking direction of the battery cells, of the pouch is between 0.001 and 0.01 inclusive.

(10) The battery module according to any one of items (1) to (9), in which the reinforcing member has a tensile strength of 1 N/mm or more.

(11) The battery module according to any one of items (1) to (10), in which the non-facing region reinforced by the reinforcing member has a tensile strength between 1 N/mm and 40 N/mm inclusive.

(12) The battery module according to any one of items (1) to (11), in which the reinforcing member includes a resin.

(13) The battery module according to any one of items (1) to (12), in which the elastic member further includes a first support member that supports at least a portion of the first sealing portion and a second support member that supports at least a portion of the second sealing portion.

(14) The battery module according to any one of items (1) to (13), in which the elastic member further includes elastic foams disposed respectively on both sides, in the stacking direction of the battery cells, of the pouch.

(15) The battery module according to any one of items (1) to (14), in which the battery cells include a cell including a negative-electrode composite layer including lithium metal or a lithium alloy, a solid electrolyte layer, and a positive-electrode composite layer.

According to the present invention, a battery module can be provided in which damage to a pouch can be reduced.

### BRIEF DESCRIPTION OF THE DRAWINGS

FIG. 1 is a side view illustrating a battery module according to an embodiment of the present invention;

FIG. 2A is a partially enlarged perspective view of the battery module of FIG. 1;

FIG. 2B is a schematic view illustrating a cross-section taken along the line A-A in FIG. 2A;

FIG. 2C is a schematic view illustrating a cross-section taken along the line B-B in FIG. 2A; and

FIG. 3 is a partially enlarged schematic view of a first elastic member of FIG. 2B.

### DETAILED DESCRIPTION OF THE INVENTION

Embodiments of the present invention will be described below with reference to the drawings.

### [Battery Module]

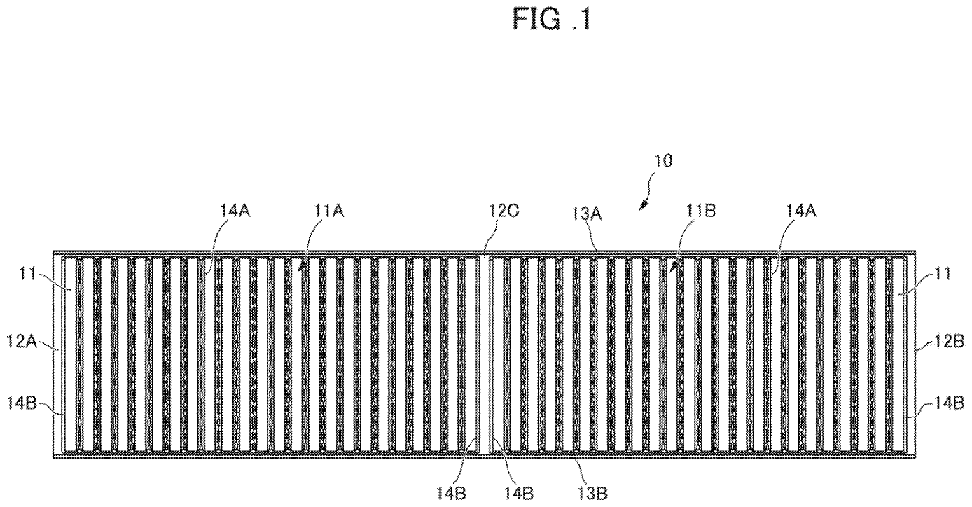

FIG. 1 illustrates a battery module according to an embodiment of the present invention.

A battery module 10 includes battery-cell laminates 11A and 11B in which a plurality of battery cells 11 are stacked, end plates 12A and 12B provided respectively at both ends, in a stacking direction, of the battery-cell laminates 11A and 11B, and a center plate 12C provided between the battery-cell laminates 11A and 11B. The battery module 10 includes bind bars 13A and 13B that restrain the battery-cell laminates 11A and 11B between the end plates 12A and 12B. A restraining pressure applied by the bind bars 13A and 13B is not particularly limited and is, for example, between 1.0 MPa and 2.5 MPa inclusive.

In the battery module 10, a first elastic member 14A is disposed between the plurality of battery cells 11, and a second elastic member 14B is disposed between the battery-cell laminate 11A and both the end plate 12A and the center plate 12C, and between the battery cell 11 and both the end plate 12B and the center plate 12C. In this case, the second elastic member 14B is in contact with one battery cell 11; therefore, the second elastic member 14B is not particularly limited as long as the second elastic member 14B has elasticity equal to or greater than half of elasticity of the first elastic member 14A that is in contact with two battery cells 11. From the viewpoint of energy density of the battery module 10, it is preferable that the second elastic member 14B have a thickness half of that of the first elastic member 14A and have the same configuration as the first elastic member 14A, but the second elastic member 14B may be identical to the first elastic member 14A.

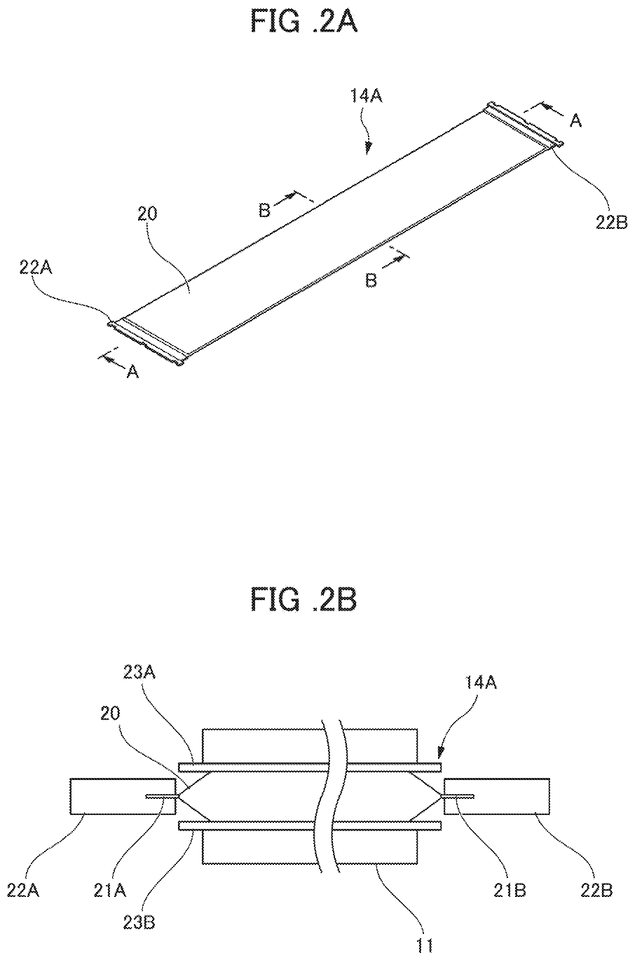

As illustrated in FIGS. 2A and 2B, the first elastic member 14A includes a pouch 20 including a first sealing portion 21A and a second sealing portion 21B at both ends, respectively, in a longitudinal direction (A-A direction) perpendicular to the stacking direction of the battery cells 11, a gas being sealed in the pouch 20, and the first elastic member 14A further includes a first support member 22A that supports an entire region of the first sealing portion 21A and a second support member 22B that supports an entire region of the second sealing portion 21B. In FIG. 2A, illustration of the battery cells 11 and elastic foams 23A and 23B described later is omitted.

In this case, the first support member 22A and the second support member 22B are positioned, for example, by positioning members provided in the battery module 10.

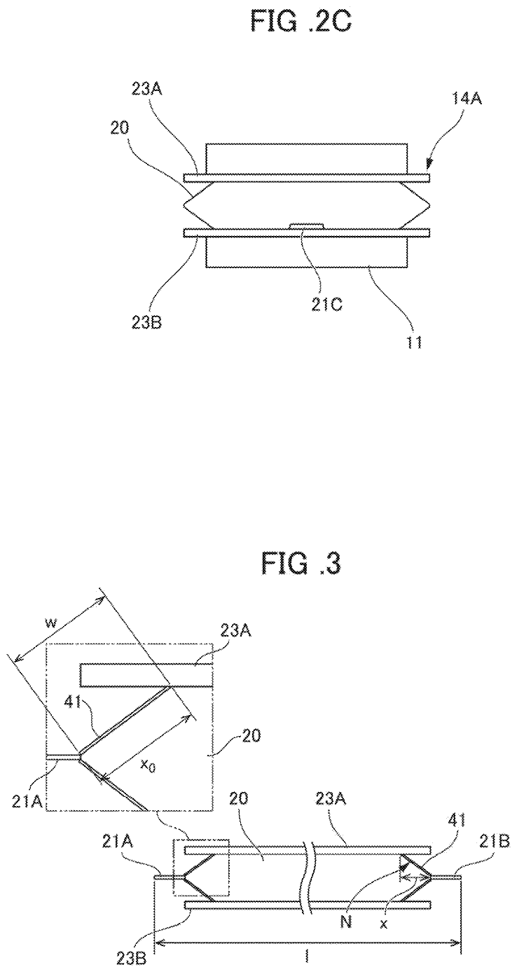

As illustrated in FIG. 3, the pouch 20 includes, in a region between the first sealing portion 21A and the second sealing portion 21B, a non-facing region N that does not face the battery cells 11 (does not face the elastic foam 23A or 23B), and the non-facing region N is reinforced by a reinforcing member 41. Therefore, even when the battery cells 11 expand and contract accompanying charging and discharging of the battery cells 11, damage to the pouch 20 is reduced. A shape of the non-facing region N is not particularly limited and may be planar or curved.

When the first elastic member 14A is viewed in cross-section from a longitudinal direction (A-A direction) perpendicular to the stacking direction of the battery cells 11, a ratio (w/x₀) of a width (w) of the reinforcing member 41 to a length (x₀) of the non-facing region N is preferably 1.0 or more. When w/x₀ is 1.0 or more, the entire non-facing region N is reinforced by the reinforcing member 41. The ratio w/x₀ is, for example, 10.0 or less.

A ratio (w/l) of the width (w) of the reinforcing member 41 to a length (l), in the longitudinal direction (A-A direction) perpendicular to the stacking direction of the battery cells 11, of the pouch 20 is preferably between 0.001 and 0.05 inclusive, more preferably between 0.002 and 0.02 inclusive, and even more preferably between 0.005 and 0.006 inclusive. When w/l is 0.001 or more, the entire non-facing region N is reinforced by the reinforcing member 41, and when w/l is 0.05 or less, energy density of the battery module 10 increases.

In this case, the length (x₀) of the non-facing region N is greater than a length (x), in the longitudinal direction (A-A direction) perpendicular to the stacking direction of the battery cells, of the non-facing region N, but a ratio x/x₀ is preferably between 0.5 and 0.9 inclusive.

A ratio of a thickness of the reinforcing member 41 to a thickness of the pouch 20, that is, a spacing between the elastic foams 23A and 23B, is preferably between 0.03 and 0.20 inclusive and even more preferably between 0.06 and 0.12 inclusive. When the ratio of the thickness of the reinforcing member 41 to the thickness of the pouch 20 is 0.03 or more, damage to the pouch 20 is more easily reduced even when the battery cells 11 expand and contract accompanying charging and discharging of the battery cells 11, and when the ratio is 0.20 or less, energy density of the battery module 10 increases.

When the first elastic member 14A is viewed in cross-section from a longitudinal direction (A-A direction) perpendicular to a stacking direction of the battery cells 11 and a length of the non-facing region N is x₀ [mm] and an internal pressure of the pouch 20 is y [N/mm²], a tensile strength of the reinforcing member 41 is preferably x₀×y [N/mm] or more. This allows damage to the pouch 20 to be more easily reduced even when the battery cells 11 expand and contract. In this case, x₀×y is preferably between 1 N/mm and 20 N/mm inclusive and even more preferably between 10 N/mm and 20 N/mm inclusive.

x₀ is preferably between 1.0 mm and 4.0 mm inclusive and even more preferably between 1.5 mm and 3.0 mm inclusive. When x₀ is 1.0 mm or more, damage to the pouch 20 is more easily reduced even when the battery cells 11 expand and contract accompanying charging and discharging of the battery cells 11, and when x₀ is 4.0 mm or less, energy density of the battery module 10 increases.

An internal pressure of the pouch 20 is preferably between 0.1 MPa and 3.0 MPa inclusive and more preferably between 0.1 MPa and 2.5 MPa inclusive. When the internal pressure of the pouch 20 is 0.1 MPa or more, uniformity of surface pressure of the first elastic member 14A increases, and when the internal pressure is 3.0 MPa or less, damage to the pouch 20 is more easily reduced even when the battery cells 11 expand and contract accompanying charging and discharging of the battery cells 11.

A ratio (x/l) of a length (x), in the longitudinal direction (A-A direction) perpendicular to a stacking direction of the battery cells 11, of the non-facing region N to a length (l), in the longitudinal direction (A-A direction) perpendicular to the stacking direction of the battery cells 11, of the pouch 20 is preferably between 0.001 and 0.01 inclusive and even more preferably between 0.001 and 0.005 inclusive. When x/l is between 0.001 and 0.01 inclusive, damage to the pouch 20 is more easily reduced even when the battery cells 11 expand and contract accompanying charging and discharging of the battery cells 11.

A tensile strength of the reinforcing member 41 is preferably 1 N/mm or more and even more preferably 4 N/mm or more. When the tensile strength of the reinforcing member 41 is 1 N/mm or more, damage to the pouch 20 is more easily reduced even when the battery cells 11 expand and contract. A tensile strength of the reinforcing member 41 is, for example, 100 N/mm or less.

A tensile strength of the non-facing region N reinforced by the reinforcing member 41 is preferably between 1 N/mm and 40 N/mm inclusive and even more preferably between 10 N/mm and 40 N/mm inclusive. When the tensile strength of the non-facing region N reinforced by the reinforcing member 41 is between 1 N/mm and 40 N/mm inclusive, damage to the pouch 20 is more easily reduced even when the battery cells 11 expand and contract accompanying charging and discharging of the battery cells 11.

An adhesive strength of the reinforcing member 41 is preferably between 0.1 N/mm and 1.0 N/mm inclusive and even more preferably between 0.3 N/mm and 0.5 N/mm inclusive. When the adhesive strength of the reinforcing member 41 is between 0.1 N/mm and 1.0 N/mm inclusive, damage to the pouch 20 is more easily reduced even when the battery cells 11 expand and contract accompanying charging and discharging of the battery cells 11.

The reinforcing member 41 preferably includes a resin. This allows damage to the pouch 20 to be more easily reduced even when the battery cells 11 expand and contract. Examples of the resin include, without limitation, polyethylene, polypropylene, polyvinyl chloride, polyester, polyurethane, silicone resin, ethylene-propylene rubber, styrene resin, olefin resin, polyamide, polyimide, and polytetrafluoroethylene. The reinforcing member 41 may include a fiber-reinforced resin.

Examples of the reinforcing member 41 include an adhesive tape. The adhesive tape includes, for example, an adhesive layer formed on a surface of a base material.

As illustrated in FIG. 2B, the first elastic member 14A further includes elastic foams 23A and 23B disposed respectively on both sides, in the stacking direction of the battery cells 11, of the pouch 20. In this case, when the first elastic member 14A is compressed due to expansion of the battery cells 11 during charging of the battery cells 11, the elastic foams 23A and 23B are interposed between the battery cells 11 and the pouch 20, and uniformity of surface pressure of the first elastic member 14A increases.

As illustrated in FIG. 2C, the pouch 20 includes a third sealing portion 21C extending in a direction (A-A direction) perpendicular to the stacking direction of the battery cells 11, and the third sealing portion 21C faces the battery cells 11. This allows the third sealing portion 21C to be reinforced by the battery cells 11 and the elastic foam 23B, thereby improving durability of the battery module 10. In this case, the third sealing portion 21C is formed on one surface of the pouch 20 that faces the battery cells 11, but the third sealing portion 21C may be formed on both surfaces of the pouch 20 that face the battery cells 11.

The pouch 20 has stretchability that allows the pouch 20 to follow expansion and contraction accompanying charging and discharging of the battery cells 11 and, as long as sealing is possible, a configuration of the pouch 20 is not particularly limited and may be, for example, a configuration in which an aluminum film is sandwiched between stretchable resin films. Examples of the stretchable resin include, without limitation, polypropylene, polyamide, and polyester.

A method of forming the first sealing portion 21A, the second sealing portion 21B, and the third sealing portion 21C is not particularly limited and may be, for example, a method in which the stretchable resin constituting the pouch 20 is thermally fused.

The pouch 20 is not particularly limited and may be, for example, a pillow pouch (commercial product). A gas sealed in the pouch 20 is not particularly limited and may be, for example, air.

Instead of the pouch 20, a pouch including the first sealing portion 21A and the second sealing portion 21B at both ends, respectively, in the direction (A-A direction) perpendicular to the stacking direction of the battery cells 11, and including a sealing portion other than the third sealing portion 21C may be used.

A material constituting the first support member 22A and the second support member 22B is not particularly limited and may be, for example, a resin or a metal.

A Poisson's ratio of the elastic foams 23A and 23B is preferably 0.3 or less. When a Poisson's ratio of the elastic foams 23A and 23B is 0.3 or less, changes in thickness accompanying expansion and contraction of the battery cells 11 are easily absorbed by the elastic foams 23A and 23B. A Poisson's ratio of the elastic foams 23A and 23B is, for example, 0.01 or more.

A thickness of the elastic foams 23A and 23B when a state of charge of the battery cells is 100% is not particularly limited and is, for example, between 0.05 mm and 0.1 mm inclusive.

A porosity of the elastic foams 23A and 23B is not particularly limited and is, for example, between 30% and 95% inclusive. A material constituting the elastic foams 23A and 23B is not particularly limited and may be, for example, polyurethane, silicone resin, ethylene-propylene rubber, styrene resin, olefin resin, polyamide, or polyester.

A method of fixing the elastic foams 23A and 23B to the pouch 20 is not particularly limited and may be, for example, a method in which the elastic foams 23A and 23B are bonded to the pouch 20 with an elastic adhesive.

### [Cell]

A cell constituting the battery cell 11 is not particularly limited and may be, for example, a solid battery cell such as an all-solid battery cell or a semi-solid battery cell, or a non-aqueous electrolyte battery cell including a negative-electrode composite layer including lithium metal or a lithium alloy. As elements other than lithium constituting the lithium alloy, examples include, without limitation, Sn, Ag, Mg, In, Si, and Al. Among these, from the viewpoint of energy density, a cell including a negative-electrode composite layer including lithium metal or a lithium alloy, a solid electrolyte layer, and a positive-electrode composite layer is preferable.

An example of an all-solid battery cell will be described below.

The all-solid battery cell includes a negative-electrode current collector, a negative-electrode composite layer including lithium metal or a lithium alloy, a solid electrolyte layer, a positive-electrode composite layer, and a positive-electrode current collector.

A material constituting the negative-electrode current collector is not particularly limited and may be, for example, silver, palladium, gold, platinum, aluminum, copper, nickel, stainless steel, or carbon. Among these, copper, stainless steel, and nickel are preferable from the viewpoints of conductivity and cost.

A shape of the negative-electrode current collector is not particularly limited and may be, for example, a foil shape, a plate shape, a mesh shape, a nonwoven shape, or a foam shape.

A solid electrolyte constituting aluminum the solid electrolyte layer is not particularly limited and may be, for example, a sulfide solid electrolyte or an oxide solid electrolyte.

A form of the solid electrolyte is not particularly limited and may be, for example, particles.

A content of the solid electrolyte in the solid electrolyte layer is not particularly limited and is, for example, between 50 mass % and 99 mass % inclusive.

The solid electrolyte layer may further include a binder or the like.

A method of forming the solid electrolyte layer is not particularly limited and may be, for example, a method in which a slurry containing the solid electrolyte and a solvent is applied.

The positive-electrode composite layer includes a positive-electrode active material. The positive-electrode active material is not particularly limited and may be, for example, lithium cobalt oxide (LiCoO₂), lithium nickel oxide (LiNiO₂), LiNiₚMn_{q}CₒᵣO₂ (p+q+r=1), LiNiₚAl_{q}CₒᵣO₂ (p+q+r=1), lithium manganese oxide (LiMn₂O₄), Li₁₊ₓMn_{2-x-y}M_{y}O₄ (x+y=2, where M is one or more elements selected from the group consisting of Al, Mg, Co, Fe, Ni, and Zn), lithium titanate, or LiMPO₄ (where M is one or more elements selected from the group consisting of Fe, Mn, Co, and Ni).

A content of the positive-electrode active material in the positive-electrode composite layer is not particularly limited and is, for example, between 50 mass % and 99 mass % inclusive.

The positive-electrode composite layer may further include a solid electrolyte. As the solid electrolyte, as long as conduction of lithium ions is possible, a material is not particularly limited and may be, for example, an oxide solid electrolyte or a sulfide solid electrolyte.

The positive-electrode composite layer may further include a binder, a conductive additive, or the like.

A method of forming the positive-electrode composite layer is not particularly limited and may be, for example, a method in which a slurry containing the positive-electrode active material and a solvent is applied.

A material constituting the positive-electrode current collector is not particularly limited and may be, for example, aluminum, an aluminum alloy, stainless steel, nickel, iron, or titanium. Among these, aluminum, an aluminum alloy, and stainless steel are preferable.

A shape of the positive-electrode current collector is not particularly limited and may be, for example, a foil shape or a plate shape.

Although embodiments of the present invention have been described above, the present invention is not limited to the embodiments described above, and the embodiments described above may be modified as appropriate within a scope of the gist of the present invention. For example, the first elastic member 14A may include the first sealing portion 21A and the second sealing portion 21B at both ends, respectively, in a short-side direction (B-B direction) perpendicular to the stacking direction of the battery cells 11.

### EXAMPLES

Examples of the present invention will be described below; however, the present invention is not limited to the examples.

### [Tensile Strength]

Using a 24G1F servopulser (manufactured by Shimadzu Corporation), tensile strength of test pieces was measured under the following conditions. In this case, test pieces punched into a dumbbell shape were prepared from the reinforcing member and from the non-facing region reinforced by the reinforcing member for measuring tensile strength.
Test speed: 0.05 mm/s
Temperature: 23° C.
Distance between chucks: 110 mm.

### Experimental Example 1

### (Reinforcement of Pouch)

A pillow pouch was used as a pouch including the first sealing portion, the second sealing portion, and the third sealing portion and sealed with air. In this case, the pouch had a width of 92 mm, a length (l) of 528 mm, a thickness of approximately 30 mm, and an internal pressure (y) of 2.5 MPa. Next, regions adjacent to the first sealing portion and regions adjacent to the second sealing portion of the pouch were reinforced with five pieces of polyvinyl-chloride adhesive tape (commercial product) as the reinforcing member. In this case, the reinforcing member had a width (w) of 19 mm, a thickness of 4.6 mm, and a tensile strength of 4.8 N/mm or more. A non-facing region reinforced by the reinforcing member had a tensile strength of 13.1 N/mm.

### (Production of Elastic Member)

Using an elastic adhesive, urethane foam (commercial product) was bonded onto both surfaces of the reinforced pouch, thereby obtaining an elastic member. In this case, the non-facing region had a length (x₀) of 1.3 mm when the elastic member was viewed in cross-section from the A-A direction, and had a length (x) of 1.3 mm in the A-A direction.

### Comparative Experimental Example 1

Except for not reinforcing the pouch with the reinforcing member, an elastic member was obtained in the same manner as in Experimental Example 1.

### [Durability]

Using a 79G3F autograph (manufactured by Shimadzu Corporation), a durability test of the elastic member was performed under the following conditions, and a cycle count at which the pouch was damaged was evaluated.
Compression/recovery speed: 0.3 mm/s
Compression: 2.5 MPa
Recovery: 1 MPa
Temperature: 23° C.

Table 1 illustrates evaluation results of durability of the elastic member.

TABLE 1

| | | COMPARATIVE |
|---|---|---|
| | EXPERIMENTAL | EXPERIMENTAL |
| | EXAMPLE1 | EXAMPLE1 |
| CYCLE COUNT | 1792 | 1030 |

From Table 1, it is understood that the elastic member of Experimental Example 1 has higher durability than the elastic member of Comparative Experimental Example 1.

### EXPLANATION OF REFERENCE NUMERALS

10: battery module
11: battery cell
11A, 11B: battery-cell laminate
12A, 12B: end plate
12C: center plate
13A, 13B: bind bar
14A: first elastic member
14B: second elastic member
20: pouch
21A: first sealing portion
21B: second sealing portion
21C: third sealing portion
22A: first support member
22B: second support member
23A, 23B: elastic foam
41: reinforcing member
N: non-facing region

What is claimed is:

1. A battery module, comprising:
a battery-cell laminate in which a plurality of battery cells are stacked; and
an elastic member disposed between the plurality of battery cells,
wherein the elastic member includes a pouch including a first sealing portion and a second sealing portion at both ends, respectively, in a direction perpendicular to a stacking direction of the battery cells, a gas being sealed in the pouch, and
the pouch includes a non-facing region, which is a region between the first sealing portion and the second sealing portion and does not face the battery cells, and the non-facing region is reinforced by a reinforcing member.

2. The battery module according to claim 1, wherein a ratio of a width of the reinforcing member to a length of the non-facing region, when the elastic member is viewed in cross-section from a direction perpendicular to the stacking direction of the battery cells, is 1.0 or more.

3. The battery module according to claim 1, wherein a ratio of a width of the reinforcing member to a length, in a direction perpendicular to the stacking direction of the battery cells, of the pouch is between 0.001 and 0.05 inclusive.

4. The battery module according to claim 1, wherein a ratio of a thickness of the reinforcing member to a thickness of the pouch is between 0.03 and 0.20 inclusive.

5. The battery module according to claim 1, wherein, when the elastic member is viewed in cross-section from a direction perpendicular to a stacking direction of the battery cells and a length of the non-facing region is x₀ [mm] and an internal pressure of the pouch is y [N/mm²], the reinforcing member has a tensile strength of x₀×y [N/mm] or more.

6. The battery module according to claim 5, wherein x₀×y is between 1 N/mm and 20 N/mm inclusive.

7. The battery module according to claim 5, wherein x₀ is between 1.0 mm and 4.0 mm inclusive.

8. The battery module according to claim 1, wherein an internal pressure of the pouch is between 0.1 MPa and 3.0 MPa inclusive.

9. The battery module according to claim 1, wherein a ratio of a length, in a direction perpendicular to the stacking direction of the battery cells, of the non-facing region to a length, in a direction perpendicular to the stacking direction of the battery cells, of the pouch is between 0.001 and 0.01 inclusive.

10. The battery module according to claim 1, wherein the reinforcing member has a tensile strength of 1 N/mm or more.

11. The battery module according to claim 1, wherein the non-facing region reinforced by the reinforcing member has a tensile strength between 1 N/mm and 40 N/mm inclusive.

12. The battery module according to claim 1, wherein the reinforcing member includes a resin.

13. The battery module according to claim 1, wherein the elastic member further includes: a first support member configured to support at least a portion of the first sealing portion; and a second support member configured to support at least a portion of the second sealing portion.

14. The battery module according to claim 1, wherein the elastic member further includes elastic foams disposed respectively on both sides, in the stacking direction of the battery cells, of the pouch.

15. The battery module according to claim 1, wherein the battery cells include a cell including a negative-electrode composite layer including lithium metal or a lithium alloy, a solid electrolyte layer, and a positive-electrode composite layer.
